(19) United States
(12) Patent Application Publication
(10) Pub. No.: US 2026/0031454 A1
(43) Pub. Date: Jan. 29, 2026

(54) Extruded Shell, Battery Pack, and Method for Assembling Battery Pack

(71) Applicant: SinoEV (Hefei) Powertrain Technology Co., Ltd, Hefei (CN)

(72) Inventors: Huadong LIU, Hefei (CN); Youliang HU, Hefei (CN); Peng ZHOU, Hefei (CN)

(73) Assignee: SinoEV (Hefei) Powertrain Technology Co., Ltd, Hefei (CN)

(21) Appl. No.: 18/782,045

(22) Filed: Jul. 24, 2024

(51) Int. Cl. H01M 50/22; H01M 10/42; H01M 50/209; H01M 50/262; H01M 50/271

(52) U.S. Cl. CPC H01M 50/22; H01M 10/425; H01M 50/209; H01M 50/262; H01M 50/271; H01M 2010/4271

(57) ABSTRACT

The embodiments of the present disclosure provide an extruded shell, a battery pack, and a method for assembling a battery pack. The extruded shell comprises a bottom plate, a T-shaped plate, and two side plates. Both side plates are connected to the bottom plate. At least one side plate extends to form a top-limiting edge. The T-shaped plate is connected to the bottom plate, and multiple single battery cells are configured to be mounted between the T-shaped plate and the side plates. The bottom plate, side plates, top-limiting edge, and T-shaped plate are integrally extruded and molded.

### BACKGROUND ART

With the rapid development of the new energy field in recent years, the form of battery packs has also been rapidly evolving. The main form of battery packs is modular, where multiple single battery cells are connected in series and parallel to form a module. Several similar modules are then connected in series and parallel and fixed together inside a lower box. The upper cover box is sealed and mounted onto the lower box, thereby ultimately forming a complete power battery pack.

### SUMMARY

The embodiments of the present disclosure provide an extruded shell, comprising
a bottom plate;
two side plates, wherein the two side plates are connected to the bottom plate; the two side plates are spaced at intervals; at least one side plate extends to form a top-limiting edge; and
a T-shaped plate, wherein the T-shaped plate is connected to the bottom plate and the T-shaped plate is provided at intervals between the two side plates; and a first assembly cavity is formed between the T-shaped plate and the side plates, and the first assembly cavity is configured to mount multiple single battery cells,
wherein the top-limiting edge and the T-shaped plate are configured to jointly limit a top of multiple single battery cells; and the bottom plate, the side plates, the top-limiting edge, and the T-shaped plate are integrally extruded and molded. The side plates, the extruded shell and the T-shaped plate are integrally formed. It is noted that the assembly cavity of the present disclosure in not limited in number.

The embodiments of the present disclosure further provide a battery pack, comprising a single battery cell, an electrical component, a front-end component, a rear-end component, a top cover component, and the extruded shell, wherein multiple single battery cells are arranged in rows inside the extruded shell. The electrical component is assembled on the multiple single battery cells; the front-end component is mounted at one end of the extruded shell, and the rear-end component is mounted at the other end of the extruded shell; and the top cover component is mounted at a top of the extruded shell.

The embodiments of the present disclosure further provide a method for assembling a battery pack, comprising
mounting the rear-end component onto the extruded shell;
packing multiple single battery cells in rows into the extruded shell from one end of the extruded shell;
mounting the front-end component, together with the battery management system unit and the connector of the electrical component, onto the extruded shell;
assembling the busbars and the sensing wires of the electrical component onto the multiple single battery cells; and
mounting the top cover component onto the extruded shell.

### BRIEF DESCRIPTION OF DRAWINGS

In order to more clearly illustrate the technical solutions of the embodiments of the present disclosure, the following will briefly introduce the drawings used in the embodiments. It should be understood that the following drawings only show some embodiments of the present disclosure, and therefore it should not be regarded as a limitation on the scope. Those ordinary skilled in the art can also obtain other related drawings based on these drawings without inventive effort.

FIG. 1 is a structural schematic view of a battery pack provided in the embodiments;

FIG. 2 is a first exploded schematic diagram of the battery pack provided in the embodiments;

FIG. 3 is a second exploded schematic diagram of the battery pack provided in the embodiments;

FIG. 4 is a structural schematic view of an extruded shell provided in a first perspective view in the embodiments; and

FIG. 5 is a structural schematic view of an extruded shell provided in a second perspective view in the embodiments.

Reference numerals: 1000—battery pack; 100—extruded shell; 101—first assembly cavity; 102—second assembly cavity; 10—bottom plate; 11—first convex strip; 12—first mounting hole; 20—side plate; 21—second convex strip; 22—second mounting hole; 30—top-limiting edge; 31—edge mounting hole; 32—first top-cover mounting hole; 40—T-shaped plate; 50—reinforcement plate; 51—first reinforcement plate; 511—third convex strip; 512—third mounting hole; 513—first connecting protrusion; 514—second top-cover mounting hole; 515—reinforcement block; 52—second reinforcement plate; 521—fourth convex strip; 522—fourth mounting hole; 523—second connecting protrusion; 524—third top-cover mounting hole; 200—single battery cell; 300—electrical component; 310—sensing wire; 320—battery management system unit; 330—connector; 340—busbar; 400—front-end component; 410—first sealing gasket; 420—appliance mounting plate; 430—second sealing gasket; 440—front-end plate; 500—rear-end component; 510—rear-end plate; 520—third sealing gasket; 600—top cover component; 610—top cover; 620—fourth sealing gasket.

### DETAILED DESCRIPTION OF EMBODIMENTS

In order to clarify the objectives, technical solutions, and advantages of the embodiments of the present disclosure, the technical solution in the embodiments of the present disclosure will be described clearly and comprehensively below in conjunction with the drawings. It is evident that the described embodiments are a part of the present disclosure, not all embodiments. The components of the embodiments of the present disclosure generally described and illustrated in the drawings herein can be arranged and designed in a variety of different configurations.

Therefore, the detailed description of the embodiments of the present disclosure provided in the drawings is not intended to limit the scope of the present disclosure for which protection is claimed, but merely to represent a selected embodiment of the present disclosure. Based on the embodiments of the present disclosure, all other embodiments obtained by those skilled in the art without inventive effort shall fall within the protection scope of the present disclosure.

It should be noted that similar numerals and letters denote similar terms in the following drawings so that once an item is defined in one drawing, it does not need to be further discussed in subsequent drawings.

In the description of the present disclosure, it should be noted that the terms “top”, “bottom”, “inner”, “outer”, and similar directional or positional terms are based on the orientation or positional relationship shown in the drawings, or they represent the customary orientation or positional relationship when the disclosed product is used. These terms are used solely for the purpose of describing the present disclosure and simplifying the description and do not indicate or imply that the device or component referred to must have a specific orientation and be constructed and operated in a particular orientation. Therefore, they should not be understood as limiting the scope of the present disclosure.

In addition, the terms, such as “first” and “second”, are only used to distinguish the descriptive and are not to be construed as indicating or implying relative importance.

It should be noted that the features in the embodiments of the present disclosure can be combined with each other without conflict.

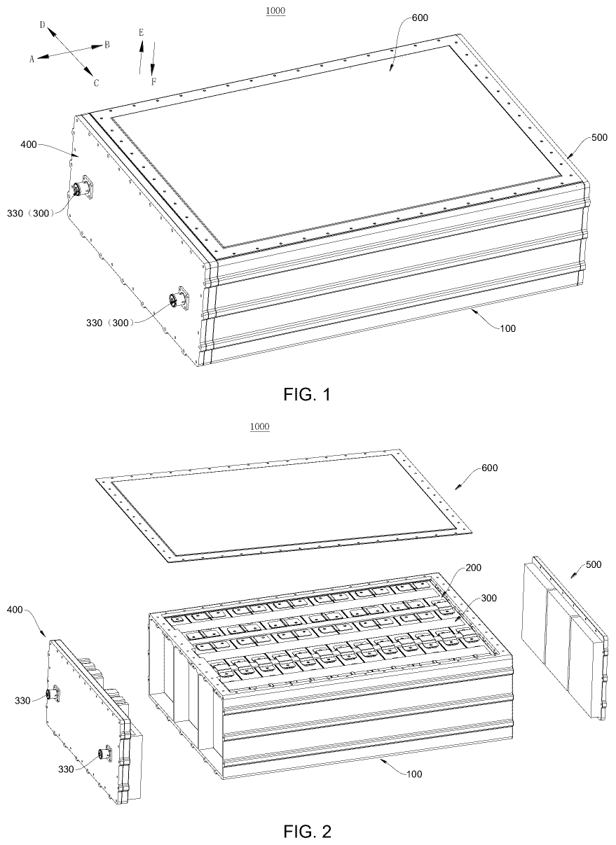

Referring to FIGS. 1 to 5, the embodiment provides an extruded shell 100, a battery pack 1000, and a method for assembling a battery pack 1000. The battery pack 1000 assembled using the extruded shell 100 can be applied in various devices such as automobiles, engineering equipment, energy storage systems, and other equipment.

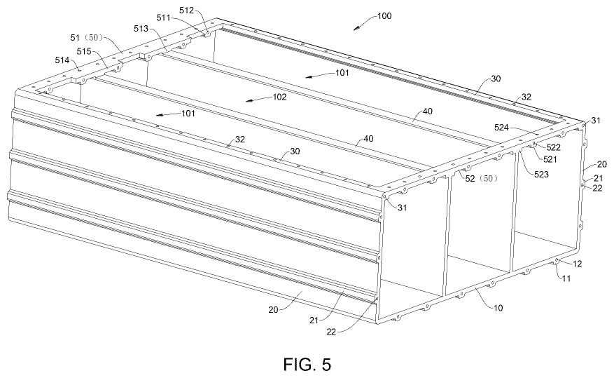

FIGS. 1 to 3 are structural schematic views of a battery pack 1000 provided in the embodiment, and FIGS. 4 to 5 are structural schematic views of an extruded shell 100 provided in the embodiment.

FIGS. 1 and 4 illustrate arrows in directions A, B, C, D, E, and F. For ease of understanding, these directions are first explained and illustrated, and the directions shown are intended to make it easy for those skilled in the art to understand the relative positions of the components of the battery pack 1000, the extruded shell 100, or the components to which they belong.

In the position of the product in the figure,
direction A can be understood as the forward direction. When referring to descriptions such as “the front end of a component”, “one end of a component”, “the other end of a component”, “the front of a component”, and so on in the following text, they can be understood in conjunction with both the textual description and the drawings. For example, the front end of a component can be understood as the end part of the component along the A direction, or the region in front of the component along the A direction.

Direction B can be understood as the rear direction. When referring to descriptions such as “the rear end of a component”, “one end of a component”, “the other end of a component”, “the rear of a component”, and so on in the following text, they can be understood in conjunction with both the textual description and the drawings. For example, the rear end of a component can be understood as the end part of the component along the B direction, or the region behind the component along the B direction.

Direction C can be understood as the left direction. When referring to descriptions such as “the left end of a component”, “one end of a component”, “the other end of a component”, “the left side of a component”, and so on in the following text, they can be understood in conjunction with both the textual description and the drawings. For example, the left end of a component can be understood as the end part of the component along the C direction, or the region to the left of the component along the C direction.

Direction D can be understood as the right direction. When referring to descriptions such as “the right end of a component”, “one end of a component”, “the other end of a component”, “the right side of a component”, and so on in the following text, they can be understood in conjunction with both the textual description and the drawings. For example, the right end of a component can be understood as the end part of the component along the D direction, or the region to the right of the component along the D direction.

Direction E can be understood as the up direction or the top direction. When referring to descriptions such as “the upper end of a component”, “one end of a component”, “the other end of a component”, “the top part of a component”, “the top end of a component”, and so on in the following text, they can be understood in conjunction with both the textual description and the drawings. For example, the top end of a component can be understood as the end part of the component along the E direction, or a region above the component along the E direction.

Direction F can be understood as the down direction or the bottom direction. When referring to descriptions such as “the lower end of a component”, “one end of a component”, “the other end of a component”, “the bottom part of a component”, “the bottom surface of a component”, and so on in the following text, they can be understood in conjunction with both the textual description and the drawings. For example, the bottom end of a component can be understood as the end part of the component along the F direction, or a region underneath the component along the F direction.

The above directions are described herein only for a better understanding of the present disclosure and are not to be construed as limiting the present disclosure. For example, when a product switches positions, the corresponding orientation description is adjusted.

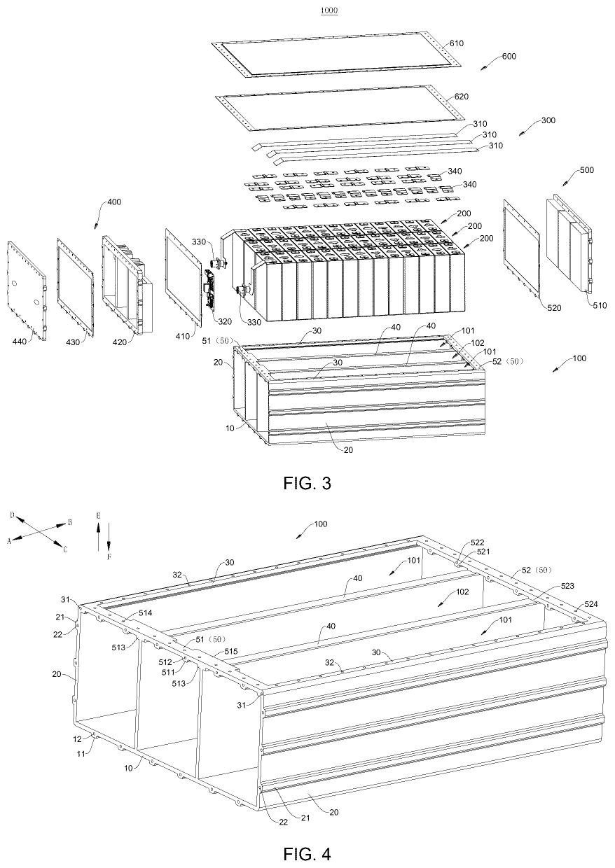

Referring to FIG. 1-FIG. 3, the battery pack 1000 includes an extruded shell 100, single battery cells 200, an electrical component 300, a front-end component 400, a rear-end component 500, and a top cover component 600. Multiple single battery cells 200 are provided. In FIGS. 2 and 3, for example, the multiple single battery cells 200 are arrayed in three rows, wherein the multiple single battery cells 200 in each row are distributed in a front-to-back direction. In other words, the multiple single battery cells 200 are provided in rows inside the extruded shell 100.

The electrical component 300 is assembled to multiple single battery cells 200, configured to perform energization, communication, and the like. Also, the front-end component 400 is mounted to one end of the extruded shell 100. It can be understood that the front-end component 400 is mounted to the front end of the extruded shell 100. The rear-end component 500 is mounted to the other end of the extruded shell 100. It can be understood that the rear-end component 500 is mounted to the rear end of the extruded shell 100. The top cover component 600 is mounted to the top part of the extruded shell 100. It can be understood that the top cover component 600 is mounted to the top of the extruded shell 100.

In FIG. 1, the single battery cell 200 is essentially completely encapsulated within the extruded shell 100, the front-end component 400, the rear-end component 500, and the top cover component 600. The majority of the electrical component 300 is encapsulated within the extruded shell 100, the front-end component 400, the rear-end component 500, and the top cover component 600. Additionally, partial structure is exposed through the front-end component 400 to facilitate power supply and communication with the outside. (more detailed below)

In conjunction with FIGS. 2 and 3, in the embodiment, the front-end component 400 comprises a first sealing gasket 410, an appliance mounting plate 420, a second sealing gasket 430, and a front-end plate 440; and the first sealing gasket 410, the appliance mounting plate 420, the second sealing gasket 430, and the front-end plate 440 are configured to be mounted on the extruded shell 100 in sequence.

In other words, during assembly, the first sealing gasket 410 is first affixed to the front end of the extruded shell 100, and then the appliance mounting plate 420, the second sealing gasket 430, and the front-end plate 440 are mounted in turn. Once assembled in place, the front-end plate 440, the second sealing gasket 430, the appliance mounting plate 420, and the first sealing gasket 410 are securely fastened to the extruded shell 100 using fasteners, wherein the fastener can include bolts or screws. Of course, in other embodiments, the front-end plate 440, the second sealing gasket 430, the appliance mounting plate 420, and the first sealing gasket 410 can also be mounted onto the extruded shell 100 in a snapping manner.

Optionally, the first sealing gasket 410 and the second sealing gasket 430 can be made of familiar materials in the field such as silicone gaskets or rubber gaskets for sealing. Optionally, the materials for the appliance mounting plate 420 and the front-end plate 440 can include familiar materials in the field such as aluminum, aluminum alloys, steel, carbon fiber reinforced composite materials, and so on.

Moreover, in the embodiment, the electrical component 300 comprises sensing wires 310, a battery management system unit 320, a connector 330, and multiple busbars 340. The sensing wires 310 are assembled on multiple single battery cells 200, and the sensing wires 310 are electrically connected to the battery management system unit 320. Thus, the battery management system unit 320 can collect data from all single battery cells 200 through the sensing wires 310, where the data includes voltage, current, capacity, and so on.

Optionally, the sensing wires 310 can be made of flexible printed circuit (FPC) boards. In FIG. 3, three sensing wires 310 are provided to match the three rows of single battery cells 200.

In the embodiment, the battery management system unit 320 is mounted onto the appliance mounting plate 420. It should be noted that during assembly, the battery management system unit 320 can be pre-assembled onto the appliance mounting plate 420. In this way, the mounting of the battery management system unit 320 can be accomplished during the assembling process of the appliance mounting plate 420 to the extruded shell 100. Then, it is connected to the sensing wires 310 via wiring. Of course, it is also possible that the appliance mounting plate 420 is first assembled to the extruded shell 100; then, the battery management system unit 320 is wired to the sensing wires 310; and finally, the battery management system unit 320 is mounted to the appliance mounting plate 420. Therefore, the specific mounting method may not be limited.

The battery management system unit 320, also known as battery management system (BMS) or referred to as the “battery nanny” or “battery steward”, is mainly for intelligently management and maintenance of each single battery cell 200, which prevents overcharging and over-discharging by monitoring the status of each single battery cell 200.

At the same time, the multiple busbars 340 are assembled to the multiple single battery cells 200. In conjunction with FIG. 3, the number of busbars 340 and the number of single battery cells 200 are matched, and the series connection and parallel connection of the multiple single battery cells 200 are realized by the busbars 340. The connector 330 is connected to the single battery cell 200 and is exposed through the front-end plate 440. The connector 330 can be plugged and cooperated with external devices or circuits. Typically, two connectors 330 are provided, with one connector 330 serving as the positive terminal of the entire battery pack 1000, and the other connector 330 serving as the negative terminal of the entire battery pack 1000.

Optionally, the front-end plate 440 is provided with two through holes to achieve the mounting and exposure of the two connectors 330. Alternatively, the front-end plate 440 and the two connectors 330 can be integrally molded, with insulation design around the connectors 330.

Optionally, in conjunction with FIGS. 2 and 3, the rear-end component 500 comprises a rear-end plate 510 and a third sealing gasket 520; and the third sealing gasket 520 and the rear-end plate 510 are configured to be mounted on the extruded shell 100 in sequence.

During assembly, the third sealing gasket 520 can be first affixed to the rear end of the extruded shell 100, and then the front-end plate 510 is assembled. Once assembled in place, the rear-end plate 510 and the third sealing gasket 520 are securely fastened to the extruded shell 100 using fasteners, wherein the fastener can include bolts or screws. Of course, in other embodiments, the rear-end plate 510 and the third sealing gasket 520 can also be mounted to the extruded shell 100 in a snapping manner.

Optionally, in conjunction with FIGS. 2 and 3, the top cover component 600 comprises a top cover 610 and a fourth sealing gasket 620; and the fourth sealing gasket 620 and the top cover 610 are configured to be mounted on the extruded shell 100 in sequence.

Similarly, during assembly, the fourth sealing gasket 620 can be first affixed to the top end of the extruded shell 100, and then the top cover 610 is assembled. Once assembled in place, the top cover 610 and the fourth sealing gasket 620 are securely fastened to the extruded shell 100 using fasteners, wherein the fastener can include bolts or screws. Of course, in other embodiments, the top cover 610 and the fourth sealing gasket 620 can also be mounted to the extruded shell 100 in a snapping manner.

Combined with FIG. 3, the extruded shell 100 provided in the embodiments is a structural component integrally extruded and molded, comprising a bottom plate 10, two side plates 20, two top-limiting edges 30, and two T-shaped plates 40. Both side plates 20 and both T-shaped plates 40 are vertically connected to the bottom plate 10. Additionally, the two T-shaped plates 40 are positioned between the two side plates 20, and the two T-shaped plates are provided at intervals, wherein each T-shaped plate is spaced at intervals with adjacent side plates 20. A first assembly cavity 101 is formed between the side plate 20 and the T-shaped plate 40, which is configured to assemble a row of single battery cells 200. A second assembly cavity 102 is formed between the two T-shaped plates 40, which is configured to assemble a row of single battery cells 200. A top of each side plate 20 extends toward the T-shaped plate 40 to form a top-limiting edge 30, and the tops of the top-limiting edge 30 and the T-shaped plate 40 are configured to jointly limit a top of multiple single battery cells 200.

Of course, the first assembly cavity 101 or the second assembly cavity 102 can also accommodate two rows of multiple single battery cells 200. Alternatively, one, three, or multiple T-shaped plates 40 can be provided.

It should be noted that in the multiple busbars 340 illustrated in FIG. 3, some of the busbars 340 are distributed in only one row of single battery cells 200. In other words, one busbar 340 connects two adjacent single battery cells 200 in one row of single battery cells 200. Of course, there are also some busbars 340 that span across two rows of single battery cells 200. In other words, one busbar 340 connects two adjacent single cells 200 in two rows of single battery cells 200. Optionally, the cross-distributed busbar 340 spans the T-shaped plate 40. Mounting the busbar 340 from the top of the T-shaped plate 40 can enable the locking of the two rows of single battery cells 200.

In conjunction with the foregoing, it can be understood that, in the multiple busbars 340, at least one of the multiple busbars 340 spans across the T-shaped plate 40. The number of the busbars 340 spanning across the T-shaped plate 40 are not limited, which can be one, two, three, or more.

In conjunction with the above, the embodiment also provides a method for assembling a battery pack 1000, wherein the method for assembling the battery pack 1000 comprises the following steps.
S1: mounting the rear-end component 500 onto the extruded shell 100. Specifically, the rear-end plate 510 and the third sealing gasket 520 are assembled onto the extruded shell 100, which is locked fixedly by the fasteners.
S2: packing multiple single battery cells 200 in rows into the extruded shell 100 from one end of the extruded shell 100. Specifically, multiple single battery cells 200 are packed from the front end of the extruded shell 100. For example, multiple single battery cells 200 are assembled in rows into the first assembly cavity 101. Optionally, multiple single battery cells 200 are assembled in rows into the second assembly cavity 102. Once assembled in place, the single battery cell 200 is confined within the extruded shell 100, thus completing the initial assembly.
S3: mounting the front-end component 400, together with the battery management system unit 320 and the connector 330 of the electrical component 300, onto the extruded shell 100. Generally, the battery management system unit 320 can be pre-assembled to the appliance mounting plate 420; and the connector 330 is assembled to the front-end plate 440. The first sealing gasket 410, the appliance mounting plate 420, the second sealing gasket 430, and the front-end plate 440 are then sequentially assembled to the extruded shell 100 and locked fixedly using fasteners.
S4: assembling the busbars 340 and the sensing wires 310 of the electrical component 300 onto the multiple single battery cells 200. Generally, using the open region of the top part of the extruded shell 100, the busbar 340 and the sensing wires 310 are assembled to the single battery cell 200, which are fixed using laser welding for example. The connector 330 is then assembled in place with the single battery cell 200, and the sensing wires 310 are wired to the battery management system unit 320.
S5: mounting the top cover component 600 onto the extruded shell 100. Specifically, the top cover 610 and the fourth sealing gasket 620 are assembled onto the extruded shell 100, which are locked fixedly using fasteners.

Therefore, by using the extruded shell 100, integrally extruded and molded, for assembling the battery pack 1000, after assembling the rear-end component 500 onto the extruded shell 100, the assembly of the single battery cell 200 can be performed. This achieves the positioning of the single battery cell 200 while accomplishing the assembly. Subsequently, the front-end component 400, the electrical component 300, and the top cover component 600 are assembled to the extruded shell 100, thus simplifying the assembly process and achieving rapid formation of the battery pack 1000.

Referring to FIGS. 4 and 5 and in conjunction with FIGS. 1-FIG. 3, the structure of the extruded shell 100 will be described in detail below.

The extruded shell 100 comprises a bottom plate 10, a T-shaped plate 40, and two side plates 20. Both side plates 20 are connected to the bottom plate 10, and the two side plates 20 are spaced at intervals. At least one side plate 20 extends to form a top-limiting edge 30. Specifically, in the embodiment, both side plates 20 extend to form top-limiting edges 30. The top-limiting edge 30 is configured to limit a top of multiple single battery cells 200. Of course, it cannot be ruled out that there is a scenario where only one side plate 20 is provided with a top-limiting edge 30.

The T-shaped plate 40 is connected to the bottom plate 10 and the T-shaped plate 40 is provided at intervals between the two side plates 20, and a first assembly cavity 101 is formed between the T-shaped plate 40 and the side plates 20. The first assembly cavity 101 is configured to mount multiple single battery cells 200. The T-shaped plate 40 is configured to limit a top of multiple single battery cells 200.

Optionally, multiple single battery cells 200 are assembled in a row in the first assembly cavity 101. It is understood that the multiple single battery cells 200 are arranged in a single row in the first assembly cavity 101. Optionally, multiple single battery cells 200 can be assembled in two rows. It is understood that the multiple single battery cells 200 are arranged in two rows in the first assembly cavity 101.

As can be seen in conjunction with the above, the top-limiting edge 30 and the T-shaped plate 40 are configured to jointly limit a top of multiple single battery cells 200. In other words, the top of the multiple single battery cells 200 located in the first assembly cavity 101 is limited, thus realizing that the single battery cell 200 cannot be dislodged from the top of the extruded shell 100.

The bottom plate 10, the side plates 20, the top-limiting edge 30, and the T-shaped plate 40 are integrally extruded and molded. In other words, the extruded shell 100 is a structural component that is integrally extruded and molded. For example, through a mold, it is extruded and molded by a method of extrusion moulding.

Extrusion moulding refers to the method of forcibly extruding malleable pug so that it can be molded through the hole mold. Typically, the material used to form the extruded shell 100 can be metal materials such as aluminum or aluminum alloys, and it can be non-metal materials such as carbon fiber reinforced composite materials.

Optionally, multiple T-shaped plates 40 are provided, and the multiple T-shaped plates 40 are spaced at intervals. A second assembly cavity 102, configured to mount multiple single battery cells 200, is formed between two adjacent T-shaped plates 40. Optionally, multiple single battery cells 200 are assembled in a row in the second assembly cavity 102. It is understood that the multiple single battery cells 200 are arranged in a single row in the second assembly cavity 102. Optionally, multiple single battery cells 200 can be assembled in two rows. It is understood that the multiple single battery cells 200 are arranged in two rows in the second assembly cavity 102. Once assembled in place, the tops of the two adjacent T-shaped plates 40 are configured to jointly limit the top of multiple single battery cells 200. In other words, the top of the multiple single battery cells 200 located in the second assembly cavity 102 is limited, thus realizing that the single battery cell 200 cannot be dislodged from the top of the extruded shell 100.

In conjunction with FIGS. 4 and 5, in the embodiment, two T-shaped plates 40 are provided. In other words, the extruded shell 100 is provided with a second assembly cavity 102 and two first assembly cavities 101 located on the left and right sides of the second assembly cavity 102. It should be noted that when multiple T-shaped plates 40 are provided, more second assembly cavities 102 are provided correspondingly so that a larger number of single battery cells 200 can be assembled.

Optionally, the bottom plate 10 is rectangular in shape; and the two side plates 20 are respectively connected to the two side edges of the bottom plate 10. The two side plates 20 are arranged in parallel, and both side plates 20 are perpendicular to the bottom plate 10. The extruded shell 100 in this manner is generally presented in a square structure.

Additionally, in the embodiment, a side of the bottom plate 10 away from the first assembly cavity 101 is provided in a protruding manner with at least one first convex strip 11, and the first convex strip 11 is integrally extruded and molded with the bottom plate 10. The first convex strip 11 can be understood as formed at the bottom part or bottom surface of the bottom plate 10. In this way, the space of the first assembly cavity 101 or the second assembly cavity 102 will not be occupied and the assembly of the single battery cell 200 will not be affected.

At the same time, the first convex strip 11 extends from one end of the bottom plate 10 to the other end. In other words, the first convex strip 11 extends from the front end to the rear end of the bottom plate 10. In a sense, the design of the first convex strip 11 also increases the strength of the bottom plate 10. In addition, the first convex strip 11 is provided with a first mounting hole 12, wherein the first mounting hole 12 penetrates through and extends from one end of the first convex strip 11 to the other end. In other words, the first mounting hole 12 penetrates through and extends from the front end to the rear end of the first convex strip 11. The front end of the first mounting hole 12 can be mated with a corresponding fastener so as to assemble the aforementioned front-end component 400. The rear end of the first mounting hole 12 can be mated with a corresponding fastener so as to assemble the aforementioned rear-end component 500.

Optionally, multiple first convex strips 11 are provided, and the multiple first convex strips 11 are parallel and are spaced at intervals. For example, in FIGS. 4 and 5, six first convex strips 11 are provided. Correspondingly, six first mounting holes 12 are provided. Certainly, the number thereof is not limited to six but can be four, five, seven, or more.

Similarly, in the embodiment, a side of at least one side plate 20 away from the first assembly cavity 101 is provided in a protruding manner with at least one second convex strip 21, and the second convex strip 21 is integrally extruded and molded with the side plate 20. The second convex strip 21 can be understood as formed at the outer side of the side plate 20. In this way, the space of the first assembly cavity 101 will not be occupied and the assembly of the single battery cell 200 will not be affected.

At the same time, the second convex strip 21 extends from one end of the side plate 20 to the other end. In other words, the second convex strip 21 extends from the front end to the rear end of the side plate 20. In a sense, the design of the second convex strip 21 also increases the strength of the side plate 20. In addition, the second convex strip 21 is provided with a second mounting hole 22, wherein the second mounting hole 22 penetrates through and extends from one end of the second convex strip 21 to the other end. In other words, the second mounting hole 22 penetrates through and extends from the front end to the rear end of the second convex strip 21. The front end of the second mounting hole 22 can be mated with a corresponding fastener so as to assemble the aforementioned front-end component 400. The rear end of the second mounting hole 22 can be configured to be mated with a corresponding fastener so as to assemble the aforementioned rear-end component 500.

Optionally, in the embodiment, both side plates 20 are provided with the second convex strips 21. Of course, it cannot be ruled out that there is a scenario where only one of the side plates 20 is provided with the second convex strip 21.

Optionally, multiple second convex strips 21 are provided, and the multiple second convex strips 21 are parallel and are spaced at intervals. For example, in FIGS. 4 and 5, the number of second convex strips 21 formed on each side plate 20 is three. Correspondingly, three second mounting holes 22 are provided. Certainly, the number thereof is not limited to three but can be two, five, seven, or more.

Similarly, in the embodiment, the top-limiting edge 30 extends from one end of the side plate 20 to the other end. The top-limiting edge 30 is provided with an edge mounting hole 31, wherein the edge mounting hole 31 penetrates through and extends from one end of the top-limiting edge 30 to the other end. In other words, the edge mounting hole 31 penetrates through and extends from the front end of the top-limiting edge 30 to the rear end.

In a sense, the design of the top-limiting edge 30 also increases the strength of the side plate 20. Therefore, the design of the edge mounting hole 31 herein can enhance the tightness of the assembly without affecting the overall strength. For example, the front end of the edge mounting hole 31 can be mated with a corresponding fastener so as to assemble the aforementioned front-end component 400. The rear end of the edge mounting hole 31 can be configured to be mated with a corresponding fastener so as to assemble the aforementioned rear-end component 500.

In addition, in order to facilitate the mounting of the top cover component 600, the top-limiting edge 30 is provided with multiple first top-cover mounting holes 32. The first top-cover mounting holes 32 can be blind holes, which can avoid affecting the single battery cell 200 inside the first assembly cavity 101.

Also, in conjunction with FIGS. 4 and 5, the extruded shell 100 further comprises at least one reinforcement plate 50; both ends of the reinforcement plate 50 are respectively connected to the top-limiting edges 30 on the two side plates 20; and the reinforcement plate 50 is connected to the T-shaped plate 40. Understandably, the left and right ends of the reinforcement plate 50 are respectively connected to the top-limiting edges 30 on the two side plates 20, and the middle position of the reinforcement plate 50 is connected to the top of the T-shaped plate 40. Additionally, the reinforcement plate 50, the top-limiting edge 30, and the T-shaped plate 40 are integrally extruded and molded.

Optionally, the at least one reinforcement plate 50 comprises a first reinforcement plate 51; and the first reinforcement plate 51 is located at one end of the two side plates 20. In other words, the first reinforcement plate 51 is located at the front end of the two side plates 20. A side of the first reinforcement plate 51 facing the bottom plate 10 is provided in a protruding manner with at least one third convex strip 511, and the third convex strip 511 is integrally extruded and molded with the first reinforcement plate 51. The third convex strip 511 is provided with a third mounting hole 512. The third mounting hole 512 is configured to be mated with a corresponding fastener so as to assemble the aforementioned front-end component 400.

Optionally, multiple third convex strips 511 are provided, and the multiple third convex strips 511 are parallel and are spaced at intervals. Specifically, in FIGS. 4 and 5, six third convex strips 511 are provided. Certainly, in practice, the number thereof is not limited to six but can be four, five, seven, or more.

Further, in the embodiment, a side of the first reinforcement plate 51 facing the bottom plate 10 is provided with a first connecting protrusion 513 in a protruding manner, and the first connecting protrusion 513 is connected with the T-shaped plate 40. The integral extrusion molding is utilized to realize an effective connection between the T-shaped plate 40 and the first reinforcement plate 51. Moreover, such a design makes the structure of the front end of the T-shaped plate 40 more stable.

Optionally, a side of the first reinforcement plate 51 facing the second reinforcement plate 52 is provided in a protruding manner with at least one reinforcement block 515. The reinforcement block 515 is designed to better cooperate with the assembly of the appliance mounting plate 420 in the front-end component 400. At the same time, the connection stability of the structure is improved.

Optionally, the first reinforcement plate 51 is provided with multiple second top-cover mounting holes 514. The multiple second top-cover mounting holes 514 are spaced apart in sequence along the direction from the left end to the right end of the first reinforcement plate 51, which is configured to be mated with a corresponding fastener so as to assemble the aforementioned top cover component 600.

Optionally, the at least one reinforcement plate 50 comprises a second reinforcement plate 52; and the second reinforcement plate 52 is located at the other end of the two side plates 20. In other words, the second reinforcement plate 52 is located at the rear end of the two side plates 20. A side of the second reinforcement plate 52 facing the bottom plate 10 is provided with in a protruding manner at least one fourth convex strip 521, and the fourth convex strip 521 is integrally extruded and molded with the second reinforcement plate 52. The fourth convex strip 521 is provided with a fourth mounting hole 522. The fourth mounting hole 522 is configured to be mated with a corresponding fastener so as to assemble the aforementioned rear-end component 500.

Optionally, multiple fourth convex strips 521 are provided, and the multiple fourth convex strips 521 are parallel and are spaced at intervals. Specifically, in FIGS. 4 and 5, six fourth convex strips 521 are provided. Certainly, in practice, the number thereof is not limited to six but can be four, five, seven, or more.

Further, in the embodiment, a side of the second reinforcement plate 52 facing the bottom plate 10 is provided with a second connecting protrusion 523 in a protruding manner, and the second connecting protrusion 523 is connected with the T-shaped plate 40. The integral extrusion molding is utilized to realize an effective connection between the T-shaped plate 40 and the second reinforcement plate 52. Moreover, such a design makes the structure of the rear end of the T-shaped plate 40 more stable.

Optionally, the second reinforcement plate 52 is provided with multiple third top-cover mounting holes 524. The multiple third top-cover mounting holes 524 are spaced apart in sequence along the direction from the left end to the right end of the second reinforcement plate 52, which is configured to be mated with a corresponding fastener so as to assemble the aforementioned top cover component 600.

In an optional embodiment,
referring to FIG. 1, the battery pack 1000 shown in FIG. 1 includes an extruded shell 100, an electrical component 300, a front-end component 400, a rear-end component 500, and a top cover component 600. The extruded shell 100 is prepared using the integral extrusion molding process. The front-end component 400 is assembled to the front end of the extruded shell 100 in the A direction. The rear-end component 500 is assembled to the rear end of the extruded shell 100 in the B direction. A top cover component 600 is assembled to the top end of the extruded shell 100 in the E direction. The electrical component 300 is assembled into the front-end component 400 and the extruded shell 100, and the connector 330 of the electrical component 300 is exposed through the front-end component 400.

Referring to FIG. 2, the battery pack 1000 shown in FIG. 2 includes an extruded shell 100, a single battery cell 200, an electrical component 300, a front-end component 400, a rear-end component 500, and a top cover component 600. The extruded shell 100 is prepared using the integral extrusion molding process. The multiple single battery cells 200 are assembled inside the extruded shell 100. The front-end component 400 is assembled to the front end of the extruded shell 100. The rear-end component 500 is assembled to another end of the extruded shell 100. A top cover component 600 is assembled to the top end of the extruded shell 100. The electrical component 300 is assembled into the front-end component 400 and the extruded shell 100, and the connector 330 of the electrical component 300 is exposed through the front-end component 400.

Referring to FIG. 3, the battery pack 1000 shown in FIG. 3 includes an extruded shell 100, a single battery cell 200, an electrical component 300, a front-end component 400, a rear-end component 500, and a top cover component 600.

The extruded shell 100 is prepared using the integral extrusion molding process. The extruded shell 100 comprises a bottom plate 10, two side plates 20, two side plates 40, two top-limiting edges 30, and two reinforcement plates 50. The bottom plate 10 is a rectangular plate. The two side plates 20 are respectively connected to the two side edges of the bottom plate 10. The two T-shaped plates 40 are connected to the bottom plate 10, and the two T-shaped plates 40 are arranged in parallel and spaced at intervals, which are located between the two side plates 20. A first assembly cavity 101 is formed between the side plate 20 and the T-shaped plate 40, which is configured to assemble a row of single battery cells 200. A second assembly cavity 102 is formed between the two T-shaped plates 40, which is configured to assemble a row of single battery cells 200. Moreover, the two T-shaped plates 40 are configured to limit the tops of multiple single battery cells 200 in a row within the second assembly cavity 102. The two top-limiting edges 30 are formed respectively at the top of the two side plates 20 and extend towards the T-shaped plate 40. The top-limiting edge 30 and the T-shaped plate 40 are jointly configured to limit the tops of multiple single battery cells 200 in a row within the first assembly cavity 101. The two reinforcement plates 50 are the first reinforcement plate 51 and the second reinforcement plate 52, respectively. Two ends of the first reinforcement plate 51 are connected to one end (front end) of the two side plates 20, and the middle position of the first reinforcement plate 51 is connected to one end (front end) of the two T-shaped plates 40. Two ends of the second reinforcement plate 52 are connected to another end (rear end) of the two side plates 20, and the middle position of the second reinforcement plate 52 is connected to another end (rear end) of the two T-shaped plates 40.

The front-end component 400 comprises a first sealing gasket 410, an appliance mounting plate 420, a second sealing gasket 430, and a front-end plate 440. The first sealing gasket 410, the appliance mounting plate 420, the second sealing gasket 430, and the front-end plate 440 are assembled to one end (front end) of the extruded shell 100 in sequence, specifically, which are assembled to the bottom plate 10 and one end (front end) of the two side plates 20 and also assembled to the first reinforcement plate 51 at the same time.

The rear-end component 500 comprises a rear-end plate 510 and a third sealing gasket 520; and the third sealing gasket 520 and the rear-end plate 510 are assembled to one end (rear end) of the extruded shell 100 in sequence, specifically, which are assembled to the bottom plate 10 and another end (rear end) of the two side plates 20 and also assembled to the second reinforcement plate 52 at the same time.

The electrical component 300 comprises sensing wires 310, a battery management system unit 320, a connector 330, and multiple busbars 340. The sensing wires 310 are assembled to the single battery cell 200 and wired to the battery management system unit 320. The battery management system unit 320 is assembled to the appliance mounting plate 420. Two connectors 330 are assembled to the front-end plate 440 of the front-end component 400 and are exposed through the front-end plate 440. The multiple busbars 340 are assembled to the multiple single battery cells 200, and configured to connect all of the single battery cells 200 in series. In the series connection, two of the single battery cells 200 located at the first and last are electrically connected to two connectors 330, respectively.

The top cover component 600 comprises a top cover 610 and a fourth sealing gasket 620, and the fourth sealing gasket 620 and the top cover 610 are assembled to the top of the extruded shell 100 in sequence. Specifically, assembly is performed on the two top-limiting edges 30 and the two reinforcement plates 50 (the first reinforcement plate 51 and the second reinforcement plate 52).

Referring to FIGS. 4 and 5, the extruded shell 100 illustrated in FIGS. 4 and 5 comprises a bottom plate 10, two side plates 20, two T-shaped plates 40, two top-limiting edges 30, and two reinforcement plates 50.

The bottom plate 10 is a rectangular plate. The bottom surface of the bottom plate 10 along the direction F is provided with multiple first convex strips 11 in a protruding manner, and each of the first convex strips 11 is penetrated to form a first mounting hole 12. One end of the first mounting hole 12 along the direction A is configured to be mated with a corresponding fastener so as to assemble the front-end component 400. One end of the first mounting hole 12 along the direction B is configured to be mated with a corresponding fastener so as to assemble the rear-end component 500. The two side plates 20 are respectively connected to the two side edges of the bottom plate 10, with multiple second convex strips 21 arranged in a protruding manner on the outer side of each side plate 20. Each second convex strip 21 is penetrated to form a second mounting hole 22. One end of the second mounting hole 22 along the direction A is configured to be mated with a corresponding fastener so as to assemble the front-end component 400. One end of the second mounting hole 22 along the direction B is configured to be mated with a corresponding fastener so as to assemble the rear-end component 500.

The two T-shaped plates 40 are connected to the bottom plate 10. The two T-shaped plates 40 are arranged in parallel and spaced at intervals, which are located between the two side plates 20. A first assembly cavity 101 is formed between the side plate 20 and the T-shaped plate 40, which is configured to assemble a row of single battery cells 200. A second assembly cavity 102 is formed between the two T-shaped plates 40, which is configured to assemble a row of single battery cells 200. Moreover, the two T-shaped plates 40 are configured to limit the tops of multiple single battery cells 200 in a row within the second assembly cavity 102.

The two top-limiting edges 30 are formed respectively at the top of the two side plates 20 and extend towards the T-shaped plate 40. The top-limiting edge 30 and the T-shaped plate 40 are jointly configured to limit the tops of multiple single battery cells 200 in a row within the first assembly cavity 101. The top-limiting edge 30 is arranged with an edge mounting hole 31 in a penetrating manner. One end of the second mounting hole 31 along the direction A is configured to be mated with a corresponding fastener so as to assemble the front-end component 400. One end of the edge mounting hole 31 along the direction B is configured to be mated with a corresponding fastener so as to assemble the rear-end component 500. The top-limiting edge 30 is further arranged with a first top-cover mounting hole 32, which is configured to be mated with a corresponding fastener so as to assemble the top cover component 600.

The two reinforcement plates 50 are the first reinforcement plate 51 and the second reinforcement plate 52, respectively. Two ends of the first reinforcement plate 51 are connected to one end (front end) of the two side plates 20, and both ends of the second reinforcement plate 52 are connected to another end (rear end) of the two side plates 20. At the same time, the middle position of the first reinforcement plate 51 is connected to one end (front end) of the two T-shaped plates, and the middle position of the second reinforcement plate 52 is connected to another end (rear end) of the two T-shaped plates. Specifically, the side of the first reinforcement plate 51 facing the bottom plate 10 is provided with a third convex strip 511 in a protruding manner. The third convex strip 511 is provided with a third mounting hole 512. The third mounting hole 512 is configured to be mated with a corresponding fastener so as to assemble the front-end component 400. The side of the first reinforcement plate 51 facing the bottom plate 10 is further provided with a first connecting protrusion 513 in a protruding manner, and the first connecting protrusion 513 is connected with the top of T-shaped plate 40. A top surface of the first reinforcement plate 51 is further arranged with a second top-cover mounting hole 514, which is configured to be mated with a corresponding fastener so as to assemble the top cover component 600. At the same time, the first reinforcement plate 51 facing the second reinforcement plate 52 is provided with at least one reinforcement block 515 in a protruding manner, which is configured to be mated with the appliance mounting plate 420 of the front-end component 400.

The side of the second reinforcement plate 52 facing the bottom plate 10 is provided with a fourth convex strip 521 in a protruding manner. The fourth convex strip 521 is provided with a fourth mounting hole 522. The fourth mounting hole 522 is configured to be mated with a corresponding fastener so as to assemble the rear-end component 500. The side of the second reinforcement plate 52 facing the bottom plate 10 is further provided with a second connecting protrusion 523 in a protruding manner, and the second connecting protrusion 523 is connected with the top of T-shaped plate 40. A top surface of the second reinforcement plate 52 is further arranged with a third top-cover mounting hole 524, which is configured to be mated with a corresponding fastener so as to assemble the top cover component 600.

### INDUSTRIAL PRACTICALITY

To summarize, the present disclosure provides an extruded shell, a battery pack, and a method for assembling a battery pack. The battery pack is assembled and molded using the extruded shell, which can simplify the assembly process.

The above are just specific embodiments of the present disclosure, but the scope of protection of the present disclosure is not limited to the embodiments. Any variations or substitutions, readily apparent to those skilled in the art within the technical scope disclosed in the present disclosure, should be encompassed within the scope of protection of the present disclosure.

What is claimed is:

1. An extruded shell, comprising
a bottom plate;
two side plates, wherein the two side plates are connected to the bottom plate; the two side plates are spaced at intervals; at least one side plate extends to form a top-limiting edge; and
a T-shaped plate, wherein the T-shaped plate is connected to the bottom plate and the T-shaped plate is provided at intervals between the two side plates; and a first assembly cavity is formed between the T-shaped plate and the side plates, and the first assembly cavity is configured to mount multiple single battery cells,
wherein the top-limiting edge and the T-shaped plate are configured to jointly limit a top of multiple single battery cells; and the bottom plate, the side plates, the top-limiting edge, and the T-shaped plate are integrally extruded and molded.

2. The extruded shell according to claim 1, wherein the bottom plate is rectangular in shape, and the two side plates are respectively connected to two side edges of the bottom plate; and the two side plates are parallelly arranged, and the two side plates are perpendicular relative to the bottom panel.

3. The extruded shell according to claim 1, wherein a side of the bottom plate away from the first assembly cavity is provided with at least one first convex strip in a protruding manner, and the first convex strip is integrally extruded and molded with the bottom plate; the first convex strip extends from one end of the bottom plate to the other end; and
the first convex strip is provided with a first mounting hole, wherein the first mounting hole penetrates through and extends from one end of the first convex strip to the other end.

4. The extruded shell according to claim 3, wherein multiple first convex strips are provided, and the multiple first convex strips are parallel and are spaced at intervals.

5. The extruded shell according to claim 1, wherein at least one of the side plates is provided in a protruding manner with at least one second convex strip on a side away from the first assembly cavity, and the second convex strip is integrally extruded and molded with the side plate; the second convex strip extends from one end of the side plate to the other end; and the second convex strip is provided with a second mounting hole, wherein the second mounting hole penetrates through and extends from one end of the second convex strip to the other end.

6. The extruded shell according to claim 5, wherein multiple second convex strips are provided, and the multiple second convex strips are parallel and are spaced at intervals.

7. The extruded shell according to claim 1, wherein the top-limiting edge extends from one end of the side plate to the other end; the top-limiting edge is provided with an edge mounting hole, wherein the edge mounting hole penetrates through and extends from one end of the top-limiting edge to the other end.

8. The extruded shell according to claim 1, wherein the top-limiting edge is provided with multiple first top-cover mounting holes.

9. The extruded shell according to claim 1, wherein multiple T-shaped plates are provided, and the multiple T-shaped plates are spaced at intervals; and a second assembly cavity, configured to mount multiple single battery cells, is formed between two adjacent T-shaped plates.

10. The extruded shell according to claim 1, wherein the extruded shell further comprises at least one reinforcement plate; both ends of the reinforcement plate are respectively connected to top-limiting edges on the two side plates; and the reinforcement plate is connected to the T-shaped plate, wherein the reinforcement plate, the top-limiting edge, and the T-shaped plate are integrally extruded and molded.

11. The extruded shell according to claim 10, wherein the at least one reinforcement plate comprises a first reinforcement plate; the first reinforcement plate is located at one end of the two side plates; a side of the first reinforcement plate facing the bottom plate is provided with at least one third convex strip in a protruding manner, and the third convex strip is integrally extruded and molded with the first reinforcement plate; the third convex strip is provided with a third mounting hole; and/or,
the at least one reinforcement plate comprises a second reinforcement plate; the second reinforcement plate is located at another end of the two side plates; a side of the second reinforcement plate facing the bottom plate is provided in a protruding manner with at least one fourth convex strip, and the fourth convex strip is integrally extruded and molded with the second reinforcement plate; and the fourth convex strip is provided with a fourth mounting hole.

12. The extruded shell according to claim 11, wherein multiple third convex strips are provided, and the multiple third convex strips are parallel and are spaced at intervals; and/or multiple fourth convex strips are provided, and the multiple fourth convex strips are parallel and are spaced at intervals.

13. The extruded shell according to claim 11, wherein a side of the first reinforcement plate facing the bottom plate is provided with a first connecting protrusion in a protruding manner, and the first connecting protrusion is connected to the T-shaped plate; and/or, a side of the second reinforcement plate facing the bottom plate is provided with a second connecting protrusion in a protruding manner, and the second connecting protrusion is connected to the T-shaped plate.

14. The extruded shell according to claim 13, wherein the first reinforcement plate is provided with multiple second top-cover mounting holes, and/or the second reinforcement plate is provided with multiple third top-cover mounting holes.

15. The extruded shell according to claim 11, wherein a side of the first reinforcement plate facing the second reinforcement plate is provided with at least one reinforcement block in a protruding manner.

16. A battery pack, comprising single battery cells, an electrical component, a front-end component, a rear-end component, a top cover component, and the extruded shell according to claim 1, wherein multiple single battery cells are arranged in rows inside the extruded shell; the electrical component is assembled on the multiple single battery cells; the front-end component is mounted at one end of the extruded shell, and the rear-end component is mounted at the other end of the extruded shell; and the top cover component is mounted at a top of the extruded shell.

17. The battery pack according to claim 16, wherein the front-end component comprises a first sealing gasket, an appliance mounting plate, a second sealing gasket, and a front-end plate; the first sealing gasket, the appliance mounting plate, the second sealing gasket, and the front-end plate are configured to be mounted on the extruded shell in sequence; and
the electrical component comprises sensing wires, a battery management system unit, a connector, and multiple busbars; the sensing wires are assembled on multiple single battery cells, and the sensing wires are electrically connected to the battery management system unit; the battery management system unit is mounted on the appliance mounting plate; the multiple busbars are assembled on the multiple single battery cells; and the connector is connected to the single battery cells and is exposed through the front-end plate.

18. The battery pack according to claim 17, wherein at least one busbar spans across the T-shaped plate.

19. The battery pack according to claim 16, wherein the rear-end component comprises a rear-end plate and a third sealing gasket; the third sealing gasket and the rear-end plate are configured to be mounted on the extruded shell in sequence; and/or,
the top cover component comprises a top cover and a fourth sealing gasket, and the fourth sealing gasket and the top cover are configured to be mounted on the extruded shell in sequence.

20. A method for assembling a battery pack, utilizing the extruded shell according to claim 1, and comprising:
mounting a rear-end component onto the extruded shell;
packing multiple single battery cells in rows into the extruded shell from one end of the extruded shell;
mounting a front-end component, together with a battery management system unit and a connector of an electrical component, onto the extruded shell;
assembling busbars and sensing wires of the electrical component onto the multiple single battery cells; and
mounting a top cover component onto the extruded shell.
